(19) United States
(12) Patent Application Publication
(10) Pub. No.: US 2025/0068049 A1
(43) Pub. Date: Feb. 27, 2025

(54) DESCENDIBLE AND SLIDING DOOR ASSEMBLY AND PROJECTION APPARATUS HAVING THE SAME

(71) Applicant: DELTA ELECTRONICS, INC., Taoyuan City (TW)

(72) Inventor: Tsang-Hsing KU, Taoyuan City (TW)

(21) Appl. No.: 18/532,604

(22) Filed: Dec. 7, 2023

(30) Foreign Application Priority Data
Aug. 23, 2023 (CN) 202311064010.7

(51) Int. Cl. G03B 21/54; G03B 21/14

(52) U.S. Cl. CPC G03B 21/54; G03B 21/145

(57) ABSTRACT

A descending and sliding door assembly includes a top cover, a carrier, and a door. The top cover includes an opening. The carrier is located below the top cover. The carrier and the top cover form a receiving tank. The door is located between the top cover and the carrier. The top cover, the door, and the carrier are disposed along a first direction. The door is capable of movably fitting in or descending from the opening along the first direction. The door slidably enters or exits the receiving tank along a second direction. The second direction is perpendicular to the first direction.

### CROSS-REFERENCE TO RELATED APPLICATION

This application claims priority to China Application Serial Number 202311064010.7, filed Aug. 23, 2023, which is herein incorporated by reference in its entirety.

### BACKGROUND

### Field of Invention

The present invention relates to a descendible sliding door assembly and projection apparatus.

### Description of Related Art

A shielding door of a current projecting apparatus is categorized as a rotation door or a sliding door. The rotation door is rotated to be opened through a rotary shaft. However, a required rotation space increases the product size. The rotary shaft is easily broken when the rotation force is excessive. The sliding door use support member to horizontally slide the door. Such method forms recess on the appearance of the projection apparatus. In addition, sliding door has no efficient fastening structure. Therefore, the door will slide and be opened by external factor when the door is not required to be opened.

Accordingly, it is still a development direction for the industry to provide a door assembly of a projection apparatus that can solve the problems mentioned above.

### SUMMARY

One aspect of the present invention is a descendible and sliding door assembly.

In one embodiment, the descendible and sliding door assembly includes a top cover comprises an opening, a carrier located below the top cover, and a door located between the top cover and the carrier. The carrier and the top cover form a receiving tank. The top cover, the door, and the carrier are disposed along a first direction. The door is capable of movably fitting in or descending from the opening along the first direction. The door slidably enters or exits the receiving tank along a second direction perpendicular to the first direction.

Another aspect of the present invention is a projection apparatus.

In one embodiment, the projection apparatus includes a housing, a descendible and sliding door assembly, and a projection operating element. The descendible and sliding door assembly includes a top cover comprises an opening, a carrier located below the top cover, and a door located between the top cover and the carrier. The carrier includes an accommodating tank under the opening, and the carrier and the top cover form a receiving tank. The top cover, the door, and the carrier are disposed along a first direction. The door is embedded in or detached from the opening along the first direction. The door slidably enters or exits the receiving tank along a second direction perpendicular to the first direction. The projection operating element is exposed from the accommodating tank.

In aforementioned embodiments, the descendible and sliding door assembly of the present disclosure can make the door to be pressed downward by the external force and slide into the receiving tank smoothly and intuitively. Therefore, it can be operated conveniently. The door can be partially embedded in the opening of the top cover. The door won't be open by external factors such as external force or shaking when the door is not required to be opened. The elastic recovery force of the elastic structures can push the door automatically to make the door embedded in the opening of the top cover again. The top cover is level with the top surface of the door when the door is embedded in the opening. As such, it can maintain the continuity and uniformity of the appearance of the projecting apparatus to avoid recess on the outer surface of the top cover. Accordingly, the product appearance integrity and practical operation convenience can be maintained.

### BRIEF DESCRIPTION OF THE DRAWINGS

The invention can be more fully understood by reading the following detailed description of the embodiment, with reference made to the accompanying drawings as follows:

FIG. 1 is a schematic of a projecting apparatus according to one embodiment of the present disclosure.

FIG. 2 is a schematic of the projecting apparatus in FIG. 1 when the door is pressed downward.

FIG. 3 is a schematic of the projecting apparatus in FIG. 2 when the door is moved away from the opening.

FIG. 4 is a cross-sectional view taken along the line 4-4 in FIG. 1.

FIG. 5 is a schematic view of FIG. 1 having the housing and the top cover removed.

FIG. 6 is a schematic of the carrier.

FIG. 7 is an enlarged view of the carrier.

FIG. 8 is a cross-sectional view taken along the line 8-8 in FIG. 6.

FIG. 9 is a cross-sectional view taken along the line 9-9 in FIG. 1.

FIG. 10 is a schematic view of FIG. 2 having the housing and the top cover removed.

FIG. 11 is a cross-sectional view taken along the line 11-11 in FIG. 2.

FIG. 12 is a schematic view of FIG. 3 having the housing and the top cover removed.

FIG. 13 is a cross-sectional view taken along the line 13-13 in FIG. 3.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

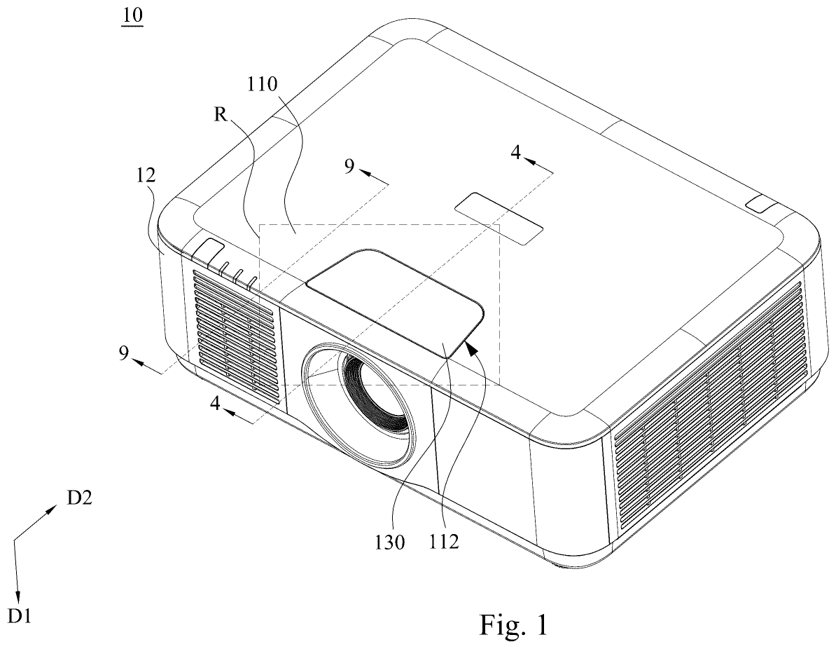

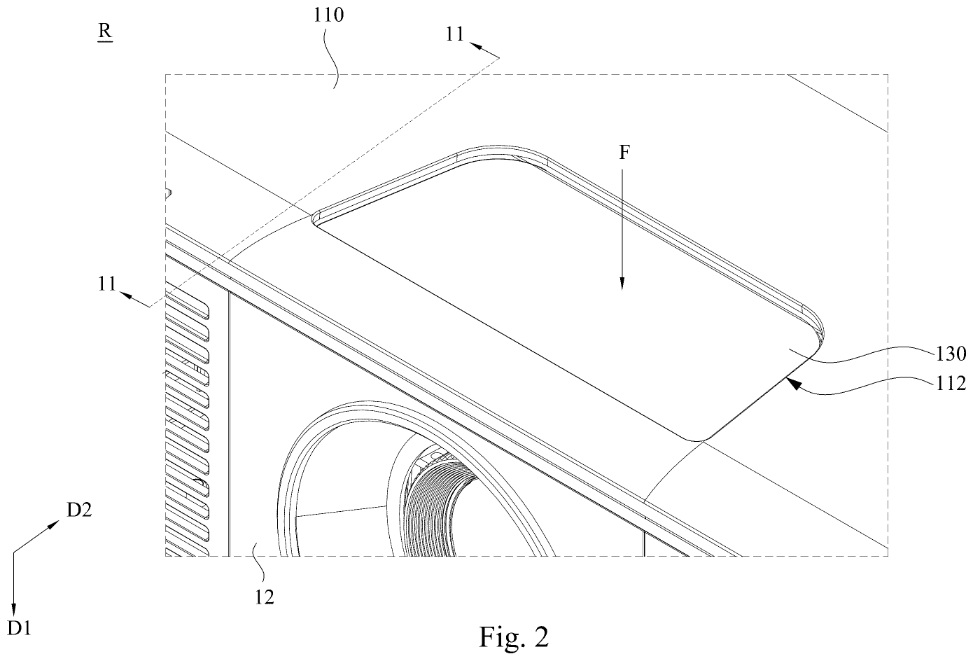

FIG. 1 is a schematic of a projecting apparatus 10 according to one embodiment of the present disclosure. The projecting apparatus 10 includes a housing 12, a top cover 110 and a door 130. The top cover 110 includes an opening 112. FIG. 2 is a schematic of the projecting apparatus 10 in FIG. 1 when the door 130 is pressed downward. FIG. 2 corresponds to the region R in FIG. 1. The door 130 in FIG. 2 is pressed downward by an external force F.

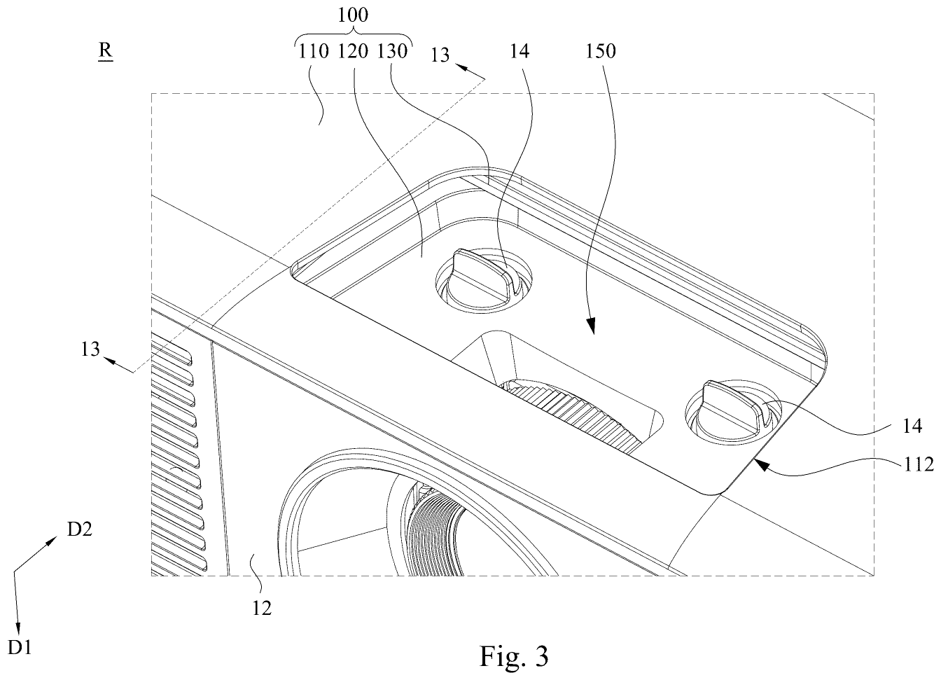

FIG. 3 is a schematic of the projecting apparatus 10 in FIG. 2 when the door 130 is moved away from the opening 112. As shown in FIG. 3, the projecting apparatus 10 includes a carrier 120 and a projection operating element 14. The carrier 120 is located below the top cover 110 and the door 130. The door 130 is located between the top cover 110 and the carrier 120. The top cover 110, the door 130, and the carrier 120 are disposed along a first direction D1. The top cover 110, the carrier 120, and the door 130 form a descendible sliding door assembly 100. The descendible sliding door assembly 100 connects the housing 12.

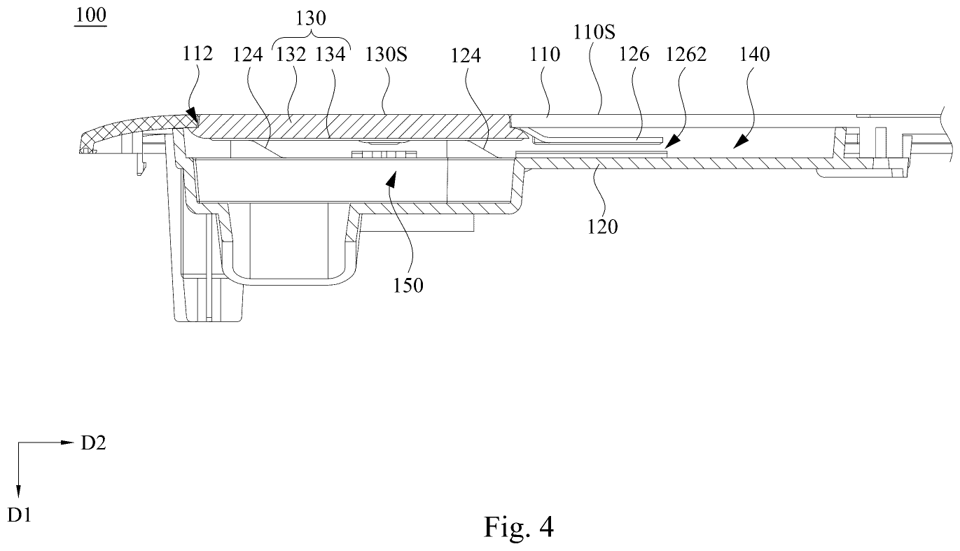

FIG. 4 is a cross-sectional view taken along the line 4-4 in FIG. 1. As shown in FIG. 3 and FIG. 4, the carrier 120 includes an accommodating tank 150 under the opening 112 of the top cover 110. The projection operating element 14 is exposed from the accommodating tank 150. The carrier 120 and the top cover 110 form a receiving tank 140 outside the region of the accommodating tank 150 and the opening 112.

As shown in FIG. 1 and FIG. 4, the door 130 covers the opening 112. A portion of the door 130 is surrounded by the top cover 110 and fitted in the opening 112, and another portion of the door 130 is located between the top cover 110 and the carrier 120. In the configuration of FIG. 2, the entire door 130 descends along the first direction D1, and the door 130 still covers the accommodating tank 150. The door 130 slidably enters or exits the receiving tank 140 along a second direction D2 perpendicular to the first direction D1. In the configuration of FIG. 3, the door 130 is removed away from the opening 112 such that the projection operating element 14 is exposed. The door 130 is received in the receiving tank 140, and most of the door 130 is shielded by the top cover 110 after being removed. The operating method of the mechanism in FIG. 2 and FIG. 3 will be described in the following paragraphs.

Through the aforesaid operation method, a user can intuitively press the door 130 downward along the first direction D1 and removes the door 130 away from the opening 112 along the second direction D2. Subsequently, adjusting the projection operating element 14 based on actual projecting requirement to control the projecting conditions such as focus or image size. After a user finished the operation, the door 130 can be reset to shield the projection operating element 14. As such, the product appearance integrity and practical operation convenience can be maintained.

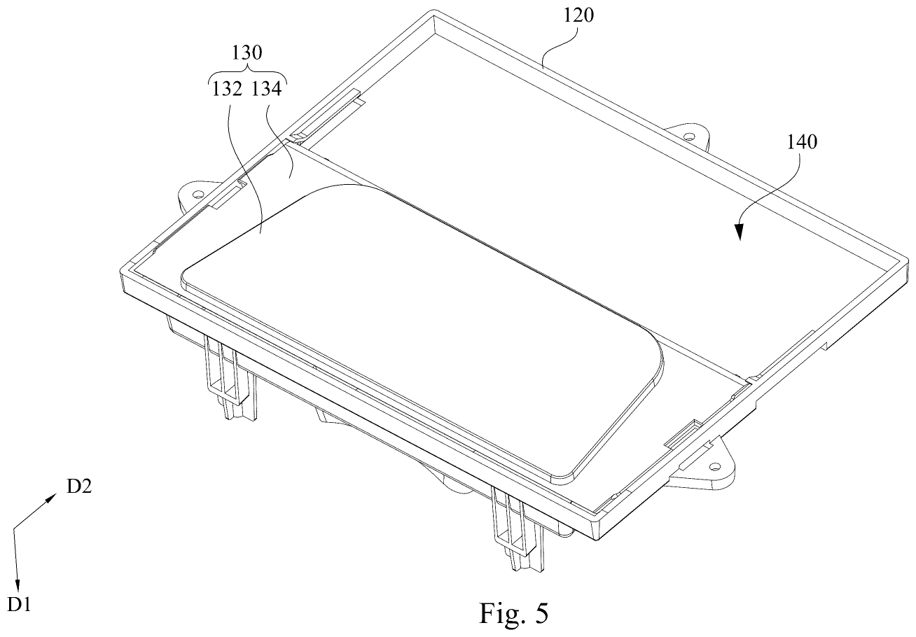

FIG. 5 is a schematic view of FIG. 1 having the housing 12 and the top cover 110 removed. As shown in FIG. 4 and FIG. 5, the door 130 includes a protruding portion 132 and a main body 134. The protruding portion 132 protrudes from the main body 134 towards the top cover 110. A top profile of the main body 134 is greater than a top profile of the protruding portion 132. The opening 112 is substantially a region receiving the protruding portion 132. In other words, a top profile of the opening 112 substantially equals the top profile of the protruding portion 132.

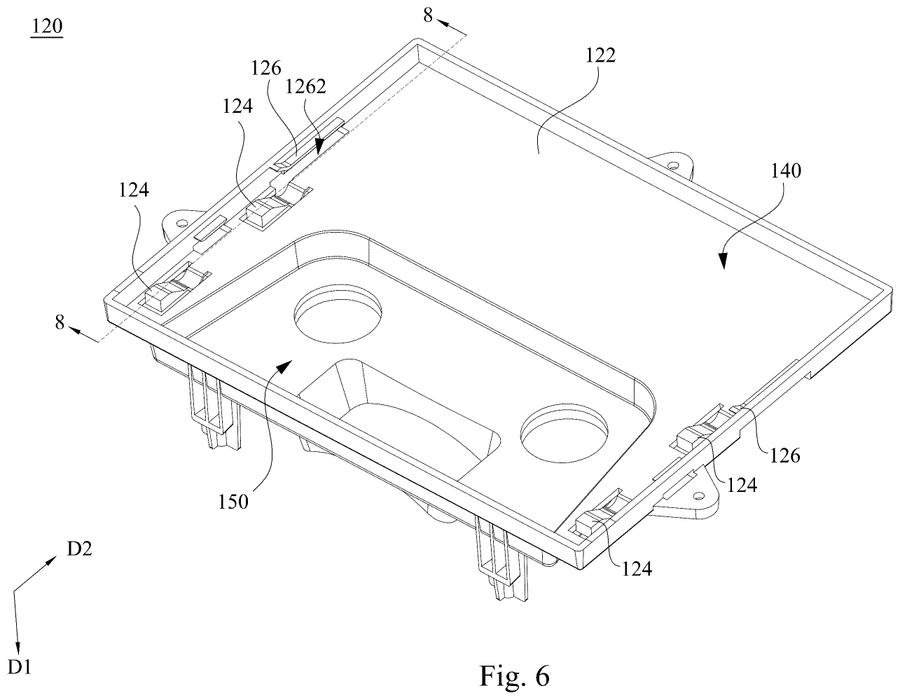

FIG. 6 is a schematic of the carrier 120. As shown in FIG. 4 and FIG. 6, the carrier 120 includes an upper surface 122 facing the door 130. The accommodating tank 150 is substantially recessed from the upper surface 122 along the first direction D1. A top profile of the accommodating tank 150 substantially equals the top profile of the protruding portion 132.

The carrier 120 includes two elastic structures 124. The elastic structures 124 protrude from the upper surface 122. The protruding portion 132 of the door 130 is movably fitted in the opening 112 along the first direction D1 through the elastic structures 124. Of two opposite edges of the carrier 120, each edge has two elastic structures 124, but the present disclosure is not limited thereto.

The carrier 120 includes a positioning structure 126 configured as a position limiting structure when the door 130 slides along the second direction D2. Of the two edges of the carrier 120, each edge has a positioning structure 126, but the present disclosure is not limited thereto.

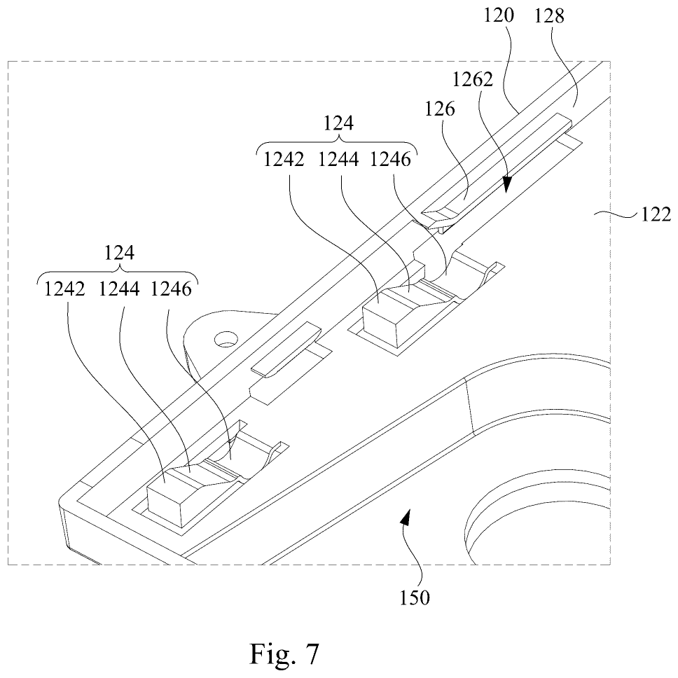

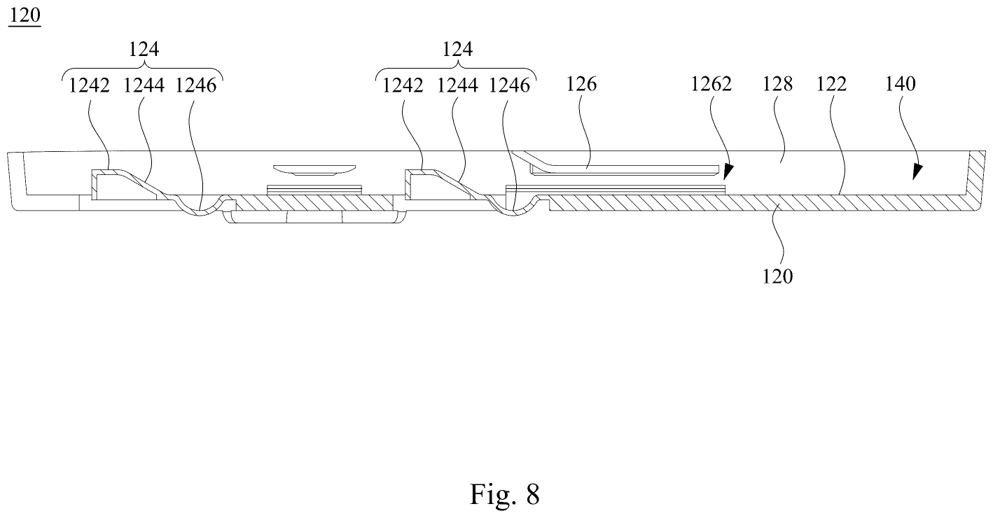

FIG. 7 is an enlarged view of the carrier 120. FIG. 8 is a cross-sectional view taken along the line 8-8 in FIG. 6. The elastic structures 124 include a top surface 1242, an inclined surface 1244, and a bending section 1246 connected with each other. The bending section 1246 connects the inclined surface 1244 and the upper surface 122. The inclined surface 1244 faces the receiving tank 140, and the top surface 1242 is substantially parallel with the upper surface 122 of the carrier 120. The bending section 1246 protrudes along the first direction D1, and the top surface 1242 and the inclined surface 1244 protrudes along a reversed direction of the first direction D1.

The carrier 120 has a side wall 128 perpendicular to the upper surface 122. The positioning structure 126 extends and protrudes from the side wall 128, and a space formed by the positioning structure 126 and the side wall 128 can be used as a sliding rail 1262 for the main body 134 (see FIG. 5) of the door 130. Specifically, the positioning structure 126 and the side wall 128 form a L-shaped continuous wall used as the sliding rail 1262.

In the present embodiment, the positioning structure 126 and the carrier 120 are integrally formed, but the present disclosure is not limited thereto. In other embodiments, the positioning structure 126 connects the top cover 110. For example, the positioning structure 126 and the top cover 110 can be integrally formed, or the positioning structure 126 can be mounted onto the top cover 110.

As shown in FIG. 7, the elastic structures 124 are spaced apart from the accommodating tank 150 in a plan view. The elastic structures 124 is spaced apart from the opening 112 (see FIG. 4) as well. Similarly, the positioning structure 126 is spaced apart from the accommodating tank 150 and the opening 112 in a plan view. That is, a vertical projection of the protruding portion 132 (see FIG. 5) of the door 130 on the carrier 120 does not overlap the elastic structures 124 and the positioning structure 126. Therefore, the elastic structures 124 and the positioning structure 126 can be shielded both when the door 130 covers the opening 112 and when the door 130 is received in the receiving tank 140.

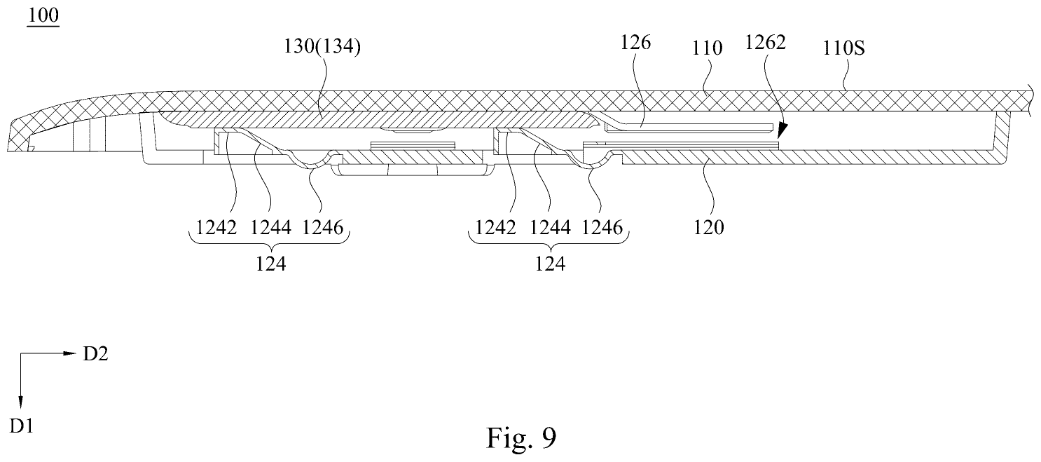

FIG. 9 is a cross-sectional view taken along the line 9-9 in FIG. 1. FIG. 1, FIG. 4, FIG. 5, and FIG. 9 all correspond to the state when the door 130 covers the opening 112. The top surface 1242 of each of the elastic structures 124 abuts the door 130. As shown in the state of FIG. 4, the top surface 130S of the door 130 is substantially level with the top surface 110S of the top cover 110. As such, it can maintain the continuity and uniformity of the appearance of the projecting apparatus 10 to avoid recess on the outer surface of the top cover 110. The protruding portion 132 of the door 130 is located in the opening 112, and is surrounded by the top cover 110. In other words, the protruding portion 132 of the door 130 is embedded in the opening 112 of the top cover 110. Therefore, the door 130 won't be open by external factors such as external force or shaking when the door 130 is not required to be opened.

As shown in FIG. 9, the main body 134 of the door 130 is pushed upward by the top surfaces 1242 of the elastic structures 124. Therefore, the main body 134 of the door 130 and the positioning structure 126 are located at the similar height, and the door cannot move along the second direction D2.

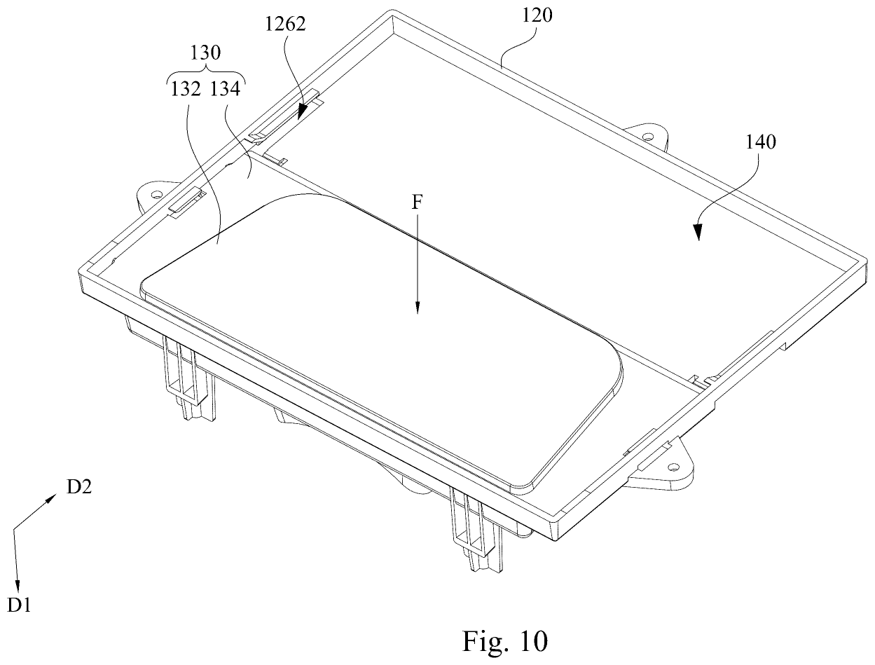

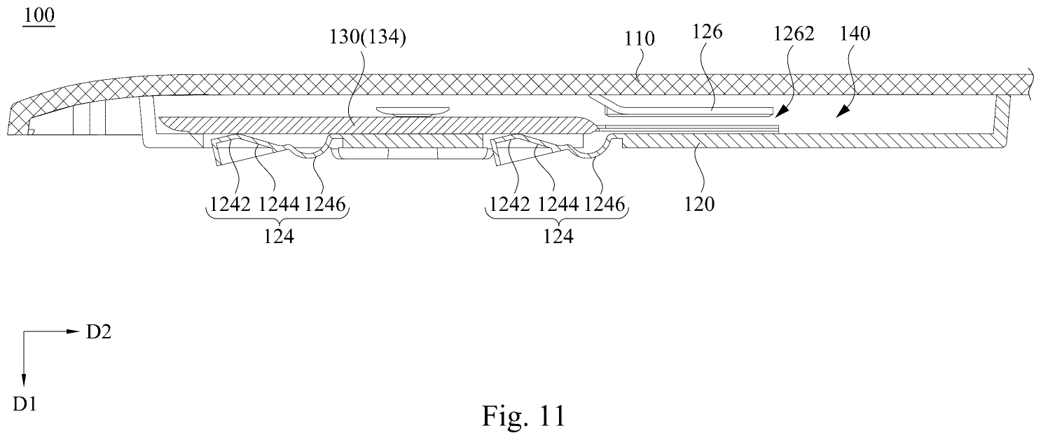

FIG. 10 is a schematic view of FIG. 2 having the housing 12 and the top cover 110 removed. FIG. 11 is a cross-sectional view taken along the line 11-11 in FIG. 2. The door 130 in FIG. 2 is pressed downward and descends along the first direction D1. As shown in FIG. 11, the door 130 moves along the first direction D1, and the elastic structures 124 located at two ends of the carrier 120 are deformed by the external force. Specifically, the elastic structures 124 are pressed downward by the main body 134 of the door 130, and the protruding portion 132 of the door 130 is detached from the opening 112 of the top cover 110 along the first direction D1. As shown in FIG. 11, a height of the position of the main body 134 of the door 130 decreased to the position under the positioning structure 126. Therefore, the main body 134 of the door 130 can slide into the sliding rails 1262 along the second direction D2 so as to move the door 130 into the receiving tank 140. Movement of being pressed downward by the external force F and sliding into the receiving tank 140 of the door 130 can be smooth and intuitive, and therefore it can be operated conveniently.

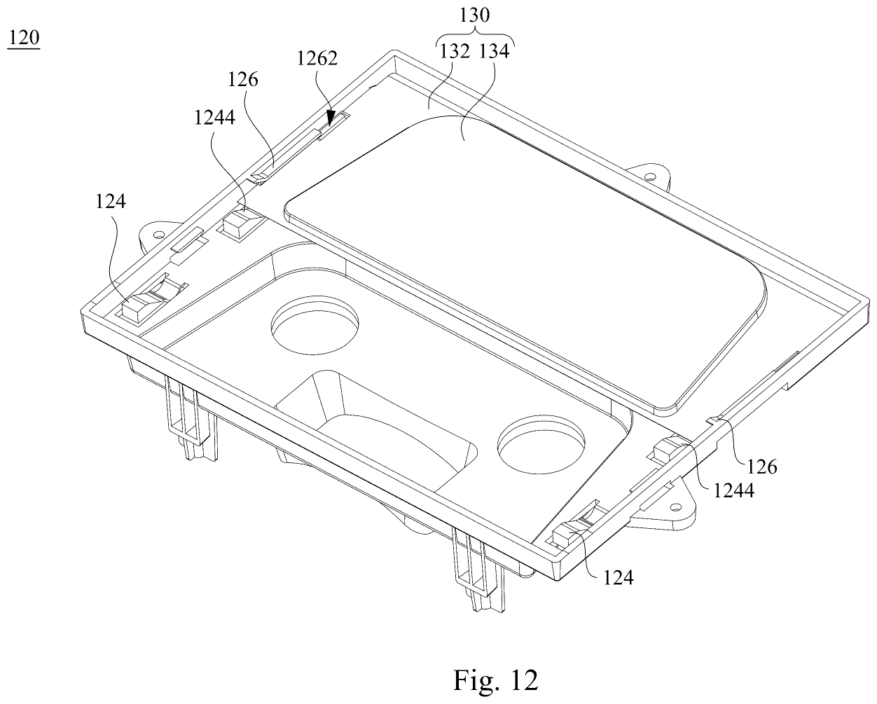

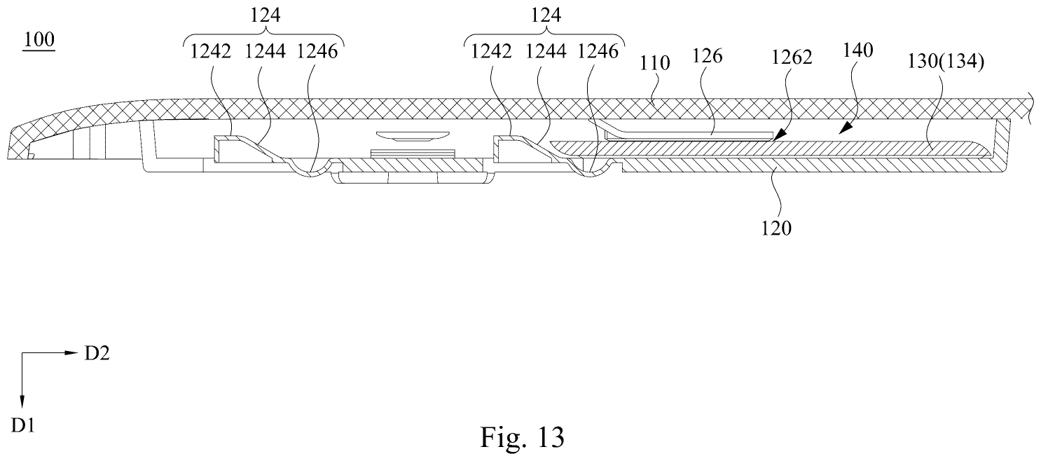

FIG. 12 is a schematic view of FIG. 3, having the housing 12 and the top cover 110 removed. FIG. 13 is a cross-sectional view taken along the line 13-13 in FIG. 3. When the door 130 is pressed downward along the first direction D1, the main body 134 of the door 130 moves into the receiving tank 140 along the second direction D2. The main body 134 of the door 130 slides along the sliding rails 1262 located at two opposite edges of the carrier 120 until the elastic structures 124 are separated from the door 130. As shown in FIG. 12, the inclined surface 1244 faces the door 130 after the elastic structures 124 are reset. Therefore, position of the door 130 along the second direction D2 is limited.

After the user finishes the operation, the door 130 is pulled back to cover the opening 112. The door 130 pressed the elastic structures 124 of the carrier 120 again. The elastic recovery force of the elastic structures 124 can push the door 130 automatically to make the protruding portion 132 of the door 130 embedded in the opening 112 of the top cover 110 again.

In summary, the descendible sliding door assembly of the present disclosure can make the door to be pressed downward by the external force and slide into the receiving tank smoothly and intuitively. Therefore, it can be operated conveniently. The door can be partially embedded in the opening of the top cover. The door won't be open by external factors such as external force or shaking when the door is not required to be opened. The elastic recovery force of the elastic structures can push the door automatically to make the door embedded in the opening of the top cover again. The top cover is level with the top surface of the door when the door is embedded in the opening. As such, it can maintain the continuity and uniformity of the appearance of the projecting apparatus to avoid recess on the outer surface of the top cover. Accordingly, the product appearance integrity and practical operation convenience can be maintained.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A descendible sliding door assembly, comprising:
a top cover comprises an opening;
a carrier located below the top cover, the carrier and the top cover forming a receiving tank; and
a door located between the top cover and the carrier, wherein the top cover, the door, and the carrier are disposed along a first direction, the door is capable of movably fitting in or descending from the opening along the first direction and slidably entering or exiting the receiving tank along a second direction perpendicular to the first direction.

2. The descendible and sliding door assembly of claim 1, wherein the carrier comprises a upper surface facing the door and an elastic structure, and the elastic structure protrudes from the upper surface.

3. The descendible and sliding door assembly of claim 2, wherein the elastic structure comprises an inclined surface and a top surface, the inclined surface faces the receiving tank, and the top surface abuts the door when the door covers the opening.

4. The descendible and sliding door assembly of claim 2, wherein the door comprises a main body and a protruding portion protruding from the main body, and wherein the protruding portion is movably fitted in the opening along the first direction through the elastic structure.

5. The descendible and sliding door assembly of claim 2, wherein the elastic structure is spaced apart from the opening in a plan view.

6. The descendible and sliding door assembly of claim 1, further comprising:
a positioning structure, wherein the positioning structure and the carrier form a sliding rail.

7. The descendible and sliding door assembly of claim 6, wherein the door comprises a main body and a protruding portion protruding from the main body, a top profile of the main body is greater than a top profile of the protruding portion, and the main body is configured to slide in the sliding rail along the second direction.

8. The descendible and sliding door assembly of claim 6, wherein the positioning structure and the carrier are integrally formed.

9. The descendible and sliding door assembly of claim 6, wherein the positioning structure connects the top cover.

10. The descendible and sliding door assembly of claim 6, wherein the positioning structure is spaced apart from the opening in a plan view.

11. A projection apparatus, comprising:
a housing;
a descendible sliding door assembly connecting the housing, wherein the descendible sliding door assembly comprises:
a top cover comprises an opening;
a carrier located below the top cover and comprising an accommodating tank under the opening, and the carrier and the top cover forming a receiving tank; and
a door located between the top cover and the carrier, wherein the top cover, the door, and the carrier are disposed along a first direction, the door is embedded in or detached from the opening along the first direction, the door slidably enters or exits the receiving tank along a second direction perpendicular to the first direction; and
a projection operating element exposed from the accommodating tank.

12. The projection apparatus of claim 11, wherein the carrier of the descendible sliding door assembly further comprises an upper surface facing the door and an elastic structure, and the elastic structure protrudes from the upper surface.

13. The projection apparatus of claim 12, wherein the elastic structure comprises an inclined surface and a top surface, the inclined surface faces the receiving tank, and the top surface abuts the door when the door covers the opening.

14. The projection apparatus of claim 13, wherein the elastic structure further comprises a bending section connecting the inclined surface of the elastic structure and the upper surface of the carrier.

15. The projection apparatus of claim 12, wherein the door comprises a main body and a protruding portion protrudes from the main body, and wherein the protruding portion is embedded in or detached from the opening along the first direction through the elastic structure.

16. The projection apparatus of claim 12, wherein the elastic structure is spaced apart from the opening in a plan view.

17. The projection apparatus of claim 11, wherein the carrier of the descendible sliding door assembly further comprises a side wall and a positioning structure, wherein the positioning structure and the side wall form a sliding rail.

18. The projection apparatus of claim 17, wherein the door comprises a main body and a protruding portion protruding from the main body, a top profile of the main body is greater than a top profile of the protruding portion, and the main body is configured to slide in the sliding rail along the second direction.

19. The projection apparatus of claim 17, wherein the positioning structure and the carrier are integrally formed.

20. The projection apparatus of claim 17, wherein the positioning structure is spaced apart from the opening in a plan view.
